(19) United States
(12) Patent Application Publication
(10) Pub. No.: US 2024/0256616 A1
(43) Pub. Date: Aug. 1, 2024

(54) ENGAGEMENT-BASED ESTIMATION OF QUERY SPECIFICITY

(71) Applicant: Walmart Apollo, LLC, Bentonville, AR (US)

(72) Inventors: Mossaab Bagdouri, Sunnyvale, CA (US); Nicole Isabel McNabb, Sunnyvale, CA (US); Krishan Sravanthi Rajanala Sai, Dublin, CA (US); Ciya Liao, Fremont, CA (US)

(73) Assignee: Walmart Apollo, LLC, Bentonville, AR (US)

(21) Appl. No.: 18/425,972

(22) Filed: Jan. 29, 2024

Related U.S. Application Data
(60) Provisional application No. 63/441,874, filed on Jan. 30, 2023.

(51) Int. Cl. G06F 16/9532; G06F 40/284; G06Q 30/0601

(52) U.S. Cl. CPC G06F 16/9532; G06F 40/284; G06Q 30/0627

(57) ABSTRACT

A system including one or more processors and one or more non-transitory computer-readable media storing computing instructions that, when executed on the one or more processors, cause the one or more processors to perform certain operations. The operations can include generating a first specificity score for a first query. The operations also can include propagating the first specificity score for the first query to generate a second specificity score for a second query. The operations additionally can include training a machine-learning classifier at least based on the first query and the second query. The operations further can include generating, using the machine-learning classifier, a third specificity score for a third query. Other embodiments are described.

### CROSS-REFERENCE TO RELATED APPLICATIONS

This application claims the benefit of U.S. Provisional Application No. 63/441,874, filed Jan. 30, 2023. U.S. Patent Application No. 63/441,874 is incorporated herein by reference in its entirety.

### TECHNICAL FIELD

This disclosure relates generally to engagement-based estimation of query specificity.

### BACKGROUND

User queries and intents are spread across a wide range of spectrum. User queries are typically understood for explicit intents. For example, there can be explicit intents for product types, brands, and other attributes. Implicit intents are more difficult to understand in user queries, but when understood well, can be used to provide more relevant search results. One difficulty in determining user intent is determining the specificity of the search query.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for engagement-based estimation of query specificity, according to an embodiment;

FIG. 4 illustrates a first pie chart showing the distribution of user engagement in response to a first search query “board games,” and a second pie chart showing the distribution of user engagement in response to a second search query “uno”;

FIG. 5 illustrates a percentage component bar chart showing the distribution of user engagement for items displayed in response to four different queries across five items during some time frame;

FIG. 6 illustrates a first pie chart showing the distribution of user engagement displayed in response to a first search query “85 in tv,” and a second pie chart showing the distribution of user engagement displayed in response to a second search query “65 in tv”;

FIG. 7 illustrates a method of using a specificity classifier, along with examples of using the specificity classifier for two different queries, according to an embodiment;

FIG. 8 illustrates a method of determining whether to display out of stock items, and if so, how to show the out-of-stock items;

FIG. 9 illustrates a display screen of a user interface showing search results for a query “frozen 2 toddler robe” without using specificity scores to show out-of-stock items;

FIG. 10 illustrates a display screen of a user interface showing search results for the query “frozen 2 toddler robe” using specificity scores to show out-of-stock items; and

FIG. 11 illustrates a flow chart for a method of providing engagement-based estimation of query specificity, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, three seconds, five seconds, or ten seconds.

### DESCRIPTION OF EXAMPLES OF EMBODIMENTS

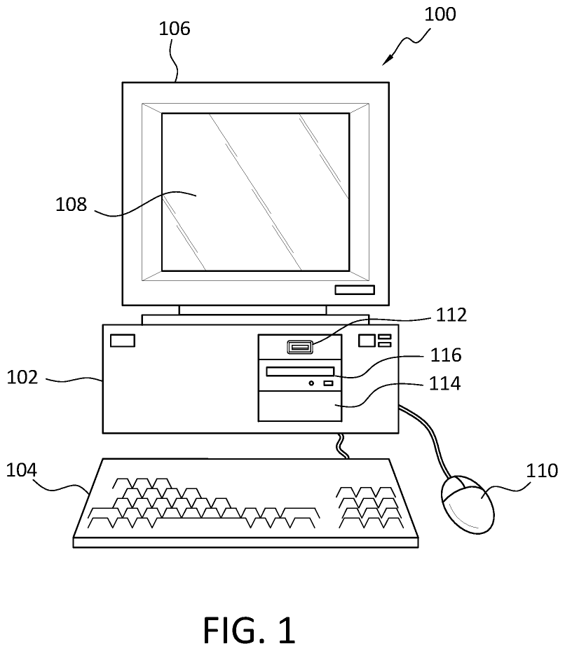

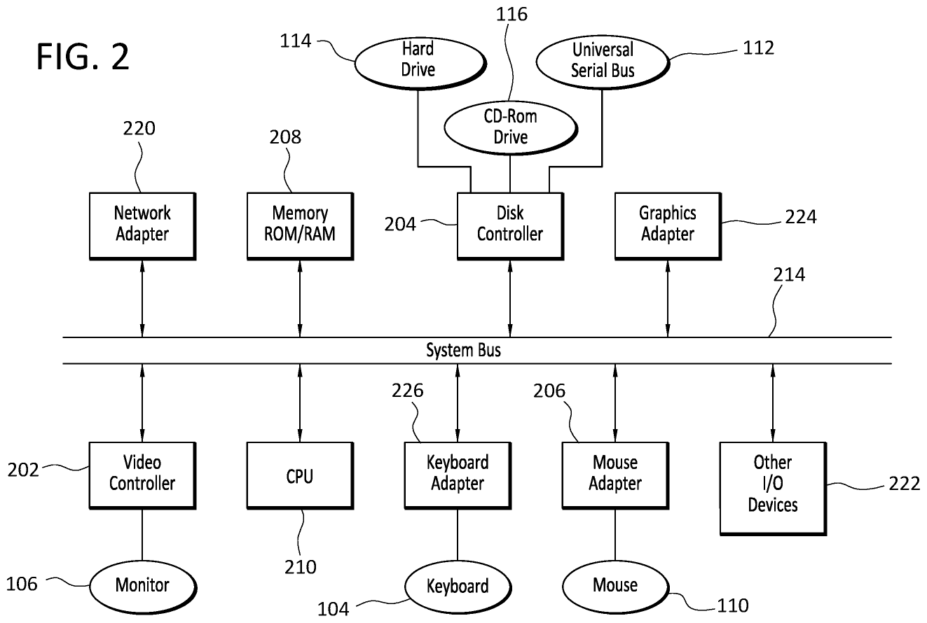

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

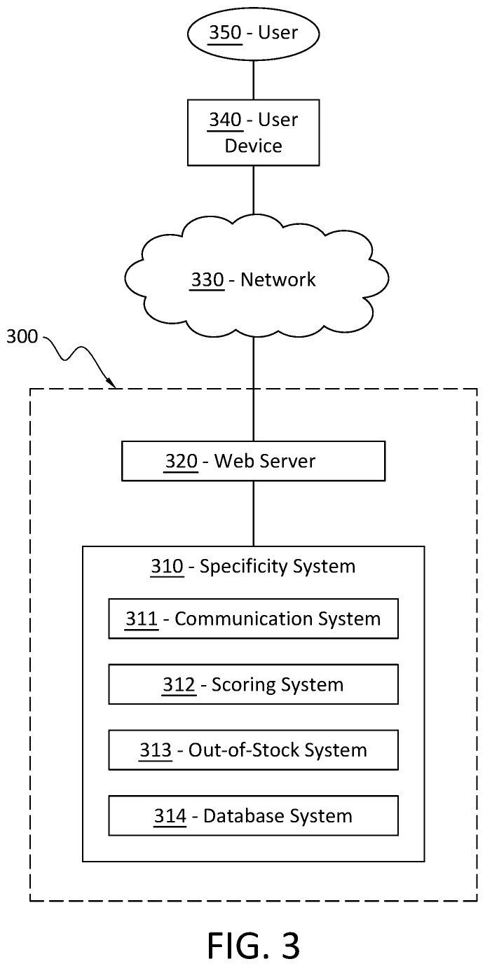

Turning ahead in the drawings, FIG. 3 illustrates a block diagram of a system 300 that can be employed for engagement-based estimation of query specificity, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a specificity system 310 and/or a web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specificity system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host specificity system 310 and/or web server 320. Additional details regarding specificity system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to search for items (e.g., products, grocery items), to add items to an electronic cart, and/or to purchase items, in addition to other suitable activities, or to interface with and/or configure specificity system 310.

In some embodiments, an internal network that is not open to the public can be used for communications between specificity system 310 and web server 320 within system 300. Accordingly, in some embodiments, specificity system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340.

In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, specificity system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to specificity system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of specificity system 310 and/or web server 320. In a similar manner, the processors and/or the non-transitory computer-readable media can be local and/or remote to each other.

Meanwhile, in many embodiments, specificity system 310 and/or web server 320 also can be configured to communicate with one or more databases, such as a database system 314. The one or more databases can include a product database that contains information about products, items, or SKUs (stock keeping units), for example, among other information, such as historical search data and specificity scores, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, specificity system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, specificity system 310 can include a communication system 311, a scoring system 312, an out-of-stock system 313, and/or database system 314. In many embodiments, the systems of specificity system 310 can be modules of computing instructions (e.g., software modules) stored at non-transitory computer readable media that operate on one or more processors. In other embodiments, the systems of specificity system 310 can be implemented in hardware. Specificity system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host specificity system 310 and/or web server 320. Additional details regarding specificity system 310 and the components thereof are described herein.

In e-commerce, user queries and intents are spread across a wide range of spectrum. User queries are typically understood for explicit intents such as product types, brands and other attributes. Other signals are implicit and provide an opportunity for serving customers better if they are understood well. In many embodiments, implicit signal and query specificity are measured using engagement-based techniques. The techniques described herein can provide an approach for sampling groups of queries from the query logs to determine specificity of queries, and can evaluate the different query specificity estimators.

Understanding user intents assists product search engines in providing most relevant and useful products/items to users. One aspect of this task is determining the specificity of the query. Query specificity can be defined as a score that captures its granularity on a spectrum of narrow to broad intent. For example, narrow queries could be expressions of intents asking for a specific product like “70-inch smart samsung tv” or “apple watch series 6 44 mm.” On the other end of the spectrum are broad queries such as “televisions” or “smart watch.”

Query specificity can provide a useful signal that can help improve results and overall shopper experience, such as in the following scenarios:
Diversity: For a broad query such as “toys,” it is typically desirable to have a varied range of toys including dolls, stuffed animals and racing cars. A specificity signal can be leveraged to enforce a diversity of items in the result set for broad queries through pre-retrieval mechanisms (e.g., by issuing multiple narrow versions of the original customer query). The user interface can also be optimized to display these diverse results.
Complementary products and services: For a narrow query like “70-inch smart samsung tv,” there could exist too few relevant results. In such cases, these results can be complemented with other related products like accessories or services such as installation and repair providers.
Query reformulation: The specificity score can be used in query reformulation (for bad performing queries) to ensure that the reformulation is acceptable (e.g., ensuring that the reformulation does not change a narrow query to a broad query or vice versa.)
Ranking signal: Ranking might depend on various signals, including best offers and location proximity, along with relevance features. Query specificity can be a useful indicator for deciding the appropriate importance of the other ranking signals. For instance, relevance features might be more important for specific queries than for broad queries. The most relevant item may not have the best offer, but could still be required to be ranked higher for specific queries such as “apple watch series 6 44 mm.”

Some approaches to defining of query specificity focus largely on the properties of the terms in the query. For example, some approaches define the specificity of a query by the number of its terms, showing a moderate correlation with manually annotated specificity scores. One can indeed consider “sofa” to be broader than “blue sectional sofa.” However, this metric fails to cover the many specific queries that can be made with a few terms, such as SKUs, ISBNs, or model numbers. Moreover, adding more words to a narrow query could reduce its specificity. For instance, the query “un65tu7000,” which refers to a unique identifier of a Samsung television is perhaps narrower than “un65tu7000 remote control,” which opens the door for universal remote controls. Some approaches address the limitations of relying solely on the query length as an indicator of its specificity by leveraging additional attributes in the query such as the existence of parts of speech, URLs (uniform resource locators), dates, and names, as well as whether the query is a question looking for an answer. Although these features are perhaps useful in the general web search space, they are rarely, if at all, present in product search queries. Some approaches formulate specificity as a function of the inverse document frequency (IDF) of the query terms. While this method solves the issue of few-term narrow queries, its failure to consider query semantics may result in semantically equivalent queries with vastly different specificity scores due to different IDF scores of synonymous terms. For example, “women's tops” and “women's blouses” may be considered semantically equivalent, but if “tops” occurs much more often in the document set than “blouses,” they may have very different specificity scores. Some approaches use neural embeddings of query terms to define term specificity by the number of its close neighbors in the embedding space. However, such approaches consider merely term specificity, without extending it to the entire query.

In many embodiments, query logs can provide some signals that can be leveraged to infer the specificity of historical queries. Such user engagement data can be leveraged to indicate the specificity of a query.

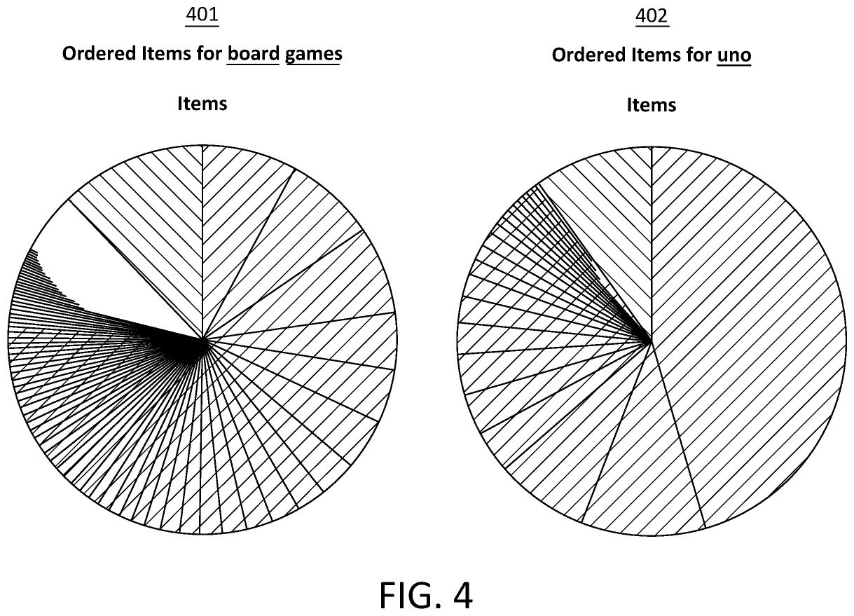

Turning ahead in the drawings, FIG. 4 illustrates a pie chart 401 showing the distribution of user engagement (for items ordered) in response to a first search query “board games,” and a pie chart 402 showing the distribution of user engagement (for items ordered) in response to a second search query “uno.” Pie charts 401-402 show that the item with the most user engagement (e.g., orders) for the second search query “uno” has more user engagement than the item with the most user engagement for the first search query “board games.” Also, the number of items with user engagement for the first search query “board games” is much higher than the number of items with user engagement for the second search query “uno.” These observations suggest that the second search query is narrower than the first search query.

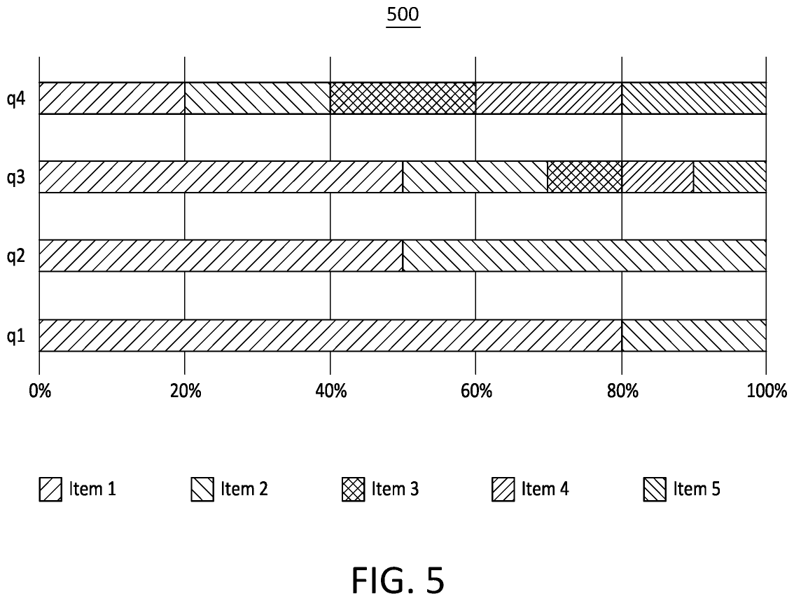

Turning ahead in the drawings, FIG. 5 illustrates a percentage component bar chart 500 showing the distribution of user engagement for items displayed in response to four different queries q1, q2, q3, and q4 across items i1, i2, i3, i4, and i5 (e.g., different SKUs) during some time frame. In this example, user engagement refers to orders, but user engagement can be other forms of engagement, such as clicks, adds to cart, etc. Below are a few comparisons across these query distributions:
Both q1 and q2 have two purchased items. But given that the top selling item of q1 has relatively more orders compared to the top selling item of q2 (i.e., 80% vs. 50%), then q1 is expected to be more specific than q2.
The top-1 selling items of q2 and q3 share same relative number of orders (i.e., 50%). But the remaining items are more diverse in q3 compared to q2. Hence, q3 is expected to be less specific than q2.
The total number of orders is distributed evenly across all purchased items in q2 and q4. But as there is more diversity in q4, q4 is expected to be less specific than q2.

In many embodiments, these understandings can be used to define and measure query specificity from historical aggregate engagement.

For a query q that generated at least one single purchase, let o_{q,i} ∈ N* be the total number of its corresponding purchases of item i, |I| ∈ N* be the count of unique purchased items I, and let r_{q,i} ∈ [0,1] be the relative number of orders covered by i, which is represented as follows:

$${r}_{q , i} = {o}_{q , i} / {\sum }_{j ∈ I} {o}_{q , i}$$

Because broad (e.g., less specific) queries generally attract orders across a large number of unique items, a specificity count S_{count} for query q can be based on the count of unique items I, as follows:

$${S}_{Count} ( q ) = {[ 1 + ln ( \vert I \vert ) ]}^{- 1}$$

The count of unique items can be dampened using natural log because there is often noise in user engagement data, in which there are orders unrelated to the query, even for very specific queries.

If a query q is very narrow, then the probability that two random customers a and b would end up buying the same item is expected to be high. This co-purchase probability P₂ is calculated as:

$${P}_{2} ( q ) = {\sum }_{i ∈ I} Probability ( a buys i ) \times Probability ( b buys i ) = {\sum }_{i ∈ I} {( {r}_{q , i} )}^{2} = {[ {L}_{2} ( q ) ]}^{2}$$

where L₂(q) is the L₂ norm of the vector whose elements are the values r_{q,i} for query q. Because the distribution of the score is close to 0, the distribution can be spread by using the L₂ norm directly instead of its square.

A base specificity score can be calculated by multiplying the specificity count and the co-purchase probability, as follows:

$${Specificity}_{B a s e} ( q ) = {L}_{2} ( q ) / [ 1 + ln ( \vert I \vert ) ]$$

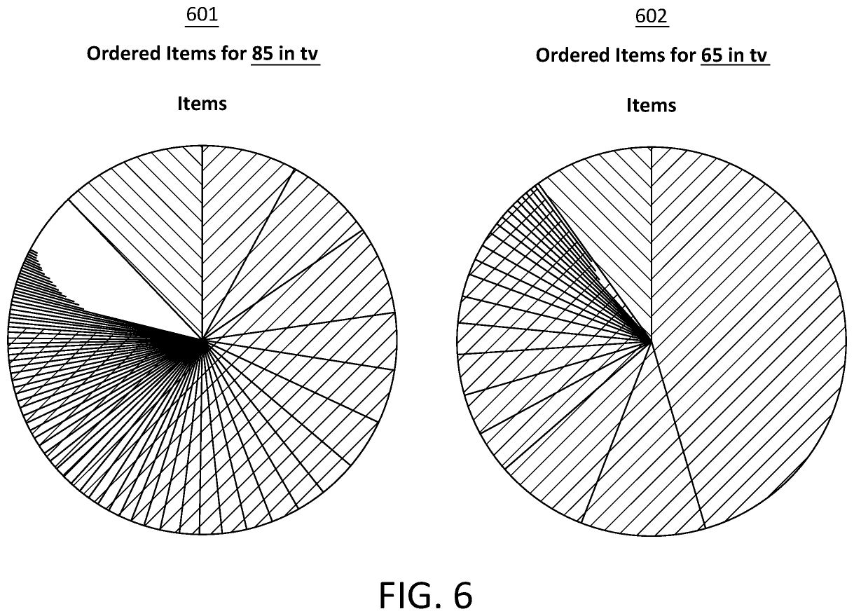

The base specificity score can provide a baseline measure of specificity. However, there can be some limitations to using this score. For example, FIG. 6 illustrates a pie chart 601 showing the distribution of user engagement (for items ordered) displayed in response to a first search query “85 in tv,” and a pie chart 602 showing the distribution of user engagement (for items ordered) displayed in response to a second search query “65 in tv.” Pie charts 601-602 show that the item with the most user engagement (e.g., orders) for the first search query has relatively more user engagement than the item with the most user engagement for the second search query, and the number of items with user engagement for the first search query is much higher than the number of items with user engagement for the second search query. These observations would suggest that the first search query is more specific, but the two search queries are at the same level of specificity.

To address this and other issues, various constraints can be imposed on specificity scores, such as the following:
Constraint 1 (C1): Regardless of the historical engagement data, if a query has more explicit attributes than another one, then it can be scored as more specific. E.g., “samsung tv” is more specific than both its subqueries “samsung” and “tv.”
Constraint 2 (C2): Different variations in explaining the same intent can result in an identical specificity across such variations. E.g., “samsung tv” and “television samsung” can be scored as having the same specificity. Queries can be normalized (to address differences in capitalization, different spellings, typographical errors or misspellings, etc.) and synonyms can be considered. These queries can be considered equivalent.
Constraint 3 (C3): Equivalent intents can be set to have an identical specificity score. E.g., “samsung tv 32in” and “samsung tv 55in” can be scored as having the same specificity. These can be considered sibling queries.
Constraint 4 (C4): Not all attributes are valid for identifying equivalent intents. E.g., “android phone” and “ios phone” do not necessarily have the same specificity, as there are typically far more Android phones on the market than iOS phones. For example, the following attributes can be eligible: gender, color, character, size, age, quantity, price; while the following attributes can be ineligible: product type, product type descriptor, brand, product line, and miscellaneous.

In many embodiments, sequence tagging can be performed on historical search queries. The sequence tagging can be performed as described in U.S. patent application Ser. No. 17/163,373, filed Jan. 30, 2021, and published as U.S. Patent Application Publication No. 2022/0245697 (hereinafter “the '697 Publication”), which is incorporated herein by reference in its entirety. For example, in the query “organic apples,” the term “organic” can be tagged as a product type descriptor feature and “apples” can be tagged as a product type.

In a number of embodiments, canonicalization can be performed on the tags. For example, one user might enter the query “almond milk organic” and another user might enter the query “organic almond milk.” In these queries, “almond milk” is a product type, and “organic” is a product type descriptor feature. Canonicalization can involve ordering the tags, so that the feature is listed before the product type.

In some embodiments, multi-attribute score propagation can be performed on queries. In some cases, the propagation can be performed on queries that have no more than 10 tags. To satisfy the constraint C2, queries can be grouped with identical intents using the query normalization logic, and the user engagement (orders) across a group of equivalent queries can be summed up (before calculating the score), which is used in the specificity score, such that the specificity score is based on the sum across the equivalent queries and each of the equivalent queries is assigned the same specificity score.

To satisfy the constraint C1 for subqueries, the following loop can be performed over queries that have more than one tag, l, and in which at least one of the tags l is product type, brand, product line, or miscellaneous:

For l ∈ [2, 10]:
For every query q with l tags:

$${Specificity}_{T m p} ( q ) = tanh [ a tanh ( {Specificity}_{B a s e} ( q ) ) + a tanh ( {max}_{q ′ ∈ q} Specificity ( {q}^{′} ) / {l}^{′} ) ]$$

The atanh moves the scores to the unbounded range [0, +∞[, and tanh squashes the scores back to the range [0, 1]. For the query “samsung 32in tv,” as an example, the following are all q′ ∈ q subqueries: “samsung”, “tv”, “32 in”, “samsung tv”, “samsung 32in”, “32 in tv”. l′ is the number of tags for the subquery q′.

To satisfy the constraints C3 and C4, the scores of sibling queries q₁ . . . qₙ can be equalized, as follows:

$$Specificity ( {q}_{1} ) = … = Specificity ( {q}_{n} ) = {max}_{i} Specificity ( {q}_{i} )$$

As an example, “samsung tv 32in” and “samsung tv 55in” are sibling queries.

In some embodiments, single-attribute score propagation can be performed on queries. Consider the example of the query “organic almond milk,” which includes tags of “almond milk” (as a product type) and “organic” (as a product type descriptor), and the query “milk,” which includes the tag “milk” (as a product type). Almond milk is a more specific term than milk, so the score propagation process described above for multi-attribute queries can be applied at the token level (e.g., space-separated) of single-attribute queries, so that Specificity(almond milk)>Specificity(milk). However, this single attribute propagation does not consider tags of different attributes, such as “almond” as a product type descriptor, and “almond milk” as a product type. Similarly, the attribute “milk” (as a product type descriptor) in “milk chocolate” is not propagated to the attribute “almond milk” (as a product type).

In many embodiments, the propagation approaches described above can be used to update specificity scores for various queries, based on equivalent queries (e.g., same intent, but different spelling, different language, etc.), sibling queries, and subqueries, after normalizing for spelling mistakes. For example, Table 1 below shows examples of queries (before normalization) and the resulting specificity score, after the constraints are applied using propagation.

TABLE 1

| Query | Specificity Score |
|---|---|
| tv | 0.179135 |
| televisions | 0.179135 |
| t.v | 0.179135 |
| televisiones | 0.179135 |
| samsung tv | 0.318171 |
| tv samsung | 0.318171 |
| samsung television | 0.318171 |
| samsung 65 inch tv | 0.558426 |
| 65 inch samsung tv | 0.558426 |
| 55 inch tv samsong | 0.558426 |
| 55-in samsung tv | 0.558426 |
| samsung55 inch tv | 0.558426 |

In many embodiments, the specificity scores generated for queries that have sufficient user engagement data (including as updated through propagation), can be used by a specificity classifier to generate specificity scores for queries with insufficient user engagement data.

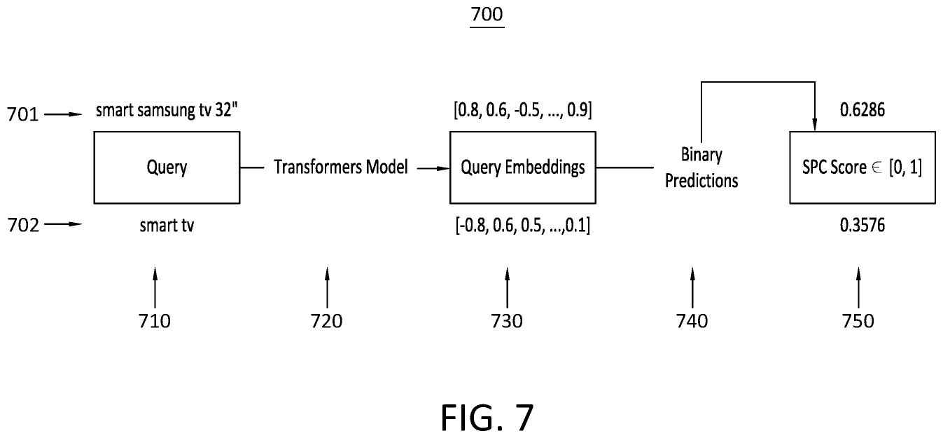

Turning ahead in the drawings, FIG. 7 illustrates a method 700 of using a specificity classifier, along with examples of using the specificity classifier for queries 701 and 702. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

As shown in FIG. 7, method 700 can include an activity 710 of receiving a query. The query can be similar or identical to query 701 (e.g., smart samsung tv 32″) and/or query 702 (e.g., smart tv).

Next, method 700 can include an activity 720 of transforming the query to query embeddings. In many embodiments, activity 720 can use a sequence transformer model, which can take the query as input and can output a vector of query embeddings.

Next, method 700 can include an activity 730 of outputting the query embeddings from the transformer model. For example, as shown in FIG. 7, for query 701, the query embeddings can be [0.8, 0.6, −0.5, . . . , 0.9], and for query 702, the query embeddings can be [−0.8, 0.6, 0.5, . . . , 0.1].

Next, method 700 can include an activity 740 of applying a specificity classifier. In many embodiments, the specificity classifier transform the query embeddings to a specificity score. In many embodiments, the specificity classifier can be a binary classifier, which can output a specificity score between 0 (representing no specificity) and 1 (representing complete specificity). For example, the score can be a sum of learned parameter weights multiplied by the respective embeddings. Each of the parameter weights can be learned during training using the specificity scores for known queries. In many embodiments, a non-linear classifier can be used. In a number of embodiments, various machine learning models can be used, such as logistic regression, k-nearest neighbors, convolutional neural network, trees, random forest, etc.

Next, method 700 can include an activity 750 of outputting the specificity (SPC) score. For example, the specificity score for query 701 can be 0.6286, and the specificity score for query 702 can be 0.3576, indicating that query 701 is more specific than query 702.

In many embodiments, the specificity classifier can be tuned using a dataset in which human labelers indicate whether query 1 is narrower, query 2 is narrower, or cannot tell. To avoid queries that are difficult to compare (and avoid too many “cannot tell” labels), such as a first query for “2% milk” and a second query for “necklaces”, a session-based sampling strategy can be used to extract unique queries issued during each session on a day, and apply the following conditions:
Each session contains exactly two unique queries with the same number of space-separated tokens, so that the query length aspect of the specificity is eliminated.
The intersection of the items shown in the search results across both queries is not empty. This condition is to ensure that those queries have some minimum degree of relatedness.
This count of intersecting items is less than half of the count of their union. This condition is to exclude duplicate and near-duplicate queries.

The resulting pairs, as subset of which is shown below in Table 2, is then used for the tuning dataset.

TABLE 2

| Broad (Less Specific) | Narrow (More Specific) |
|---|---|
| orange juice | sunny d |
| small table | folding table |
| vegetable scrubber | potato scrubber |
| dried fruit | dried strawberries |
| twin size mattress pad | fitted twin mattress cover |
| can fuel | butane fuel |

In many embodiments, when a query has a specificity score, that specificity score can be used in various different use cases. For example, if the specificity score for a query is higher than a threshold, then the results displayed for the search query can be different than if the specificity score for the query is lower than a threshold. An exemplary use case is whether to display out-of-stock items in the search results for a query. Broad queries (e.g., “samsung tv”, or “toys for toddlers”) generally have many in-stock items that are relevant substitutes. But narrower queries (e.g., “bananas”, “old spiec fiji gift set”) generally have fewer or no relevant substitutes, and the user often would like to know in such cases that the item is out of stock. To address this issue, out-of-stock items can be displayed for queries that have a specificity score above a threshold (e.g., >=0.5).

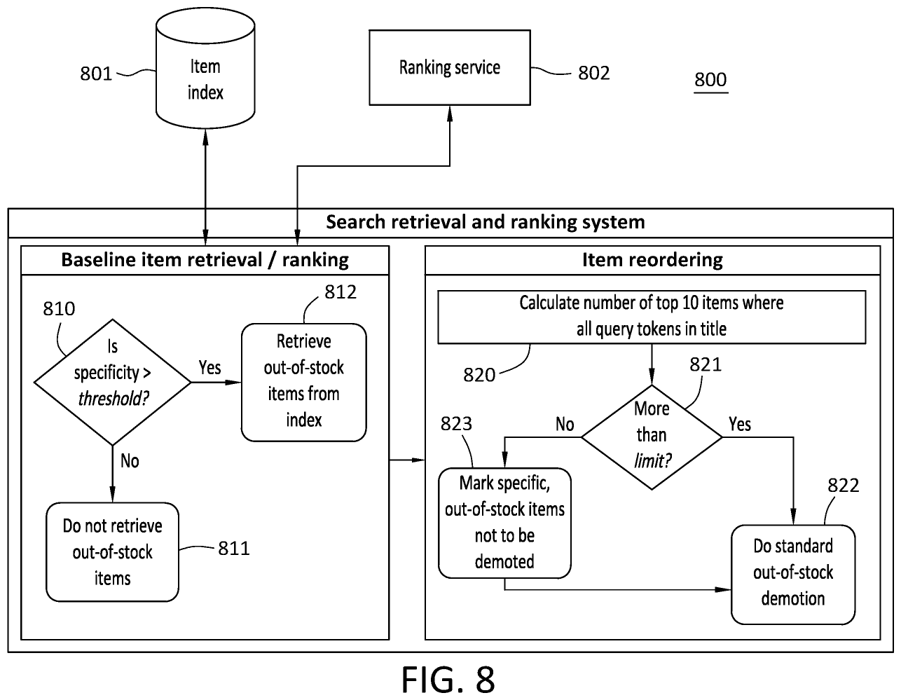

Turning ahead in the drawings, FIG. 8 illustrates a method 800 of determining whether to display out of stock items, and if so, how to show the out-of-stock items. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of method 800 can be performed in any suitable order. In still other embodiments, one or more of the procedures, the processes, and/or the activities of method 800 can be combined or skipped.

As shown in FIG. 8, method 800 can include an activity 810 of determining if the specificity score exceeds a threshold. In some embodiments, the specificity score can be retrieved from a ranking service 802. If the outcome of activity 810 is no, method 800 can include an activity 811 of not retrieving or showing out-of-stock items. If the outcome of activity 810 is yes, method 800 can include an activity 812 of retrieving out-of-stock items from an item index 801. In many embodiments, the next phase of method 800 can involve determining how to show the out-of-stock items in the search results. For example, in this phase, method 800 can include an activity 820 of determining the number of out-of-stock items in the top search results (e.g., top 10, or another suitable number) that include all the query tokens in the title of the item, as out-of-stock are not shown if they are for a different query. For example, if the query is for “samsung 55 in” then an out-of-stock item with the title “Samsung 55 in TV” can be included, but not an out-of-stock item with the title “Samsung 75 in TV”. The number of out-of-stock items that satisfy this condition can be calculated. Method 800 can include an activity 821 of determining if that number is more than a limit (e.g., 1, 2, 3, 4, 5, or another suitable number). If the outcome of activity 821 is yes, method 800 can include an activity 822 of demoting those out-of-stock items that satisfy the condition that are lower in the ranking of top items, such that they are not shown in the results, while those that are within the limit are shown. Otherwise, if the outcome of activity 821 is no, method 800 can include an activity 823 of showing the out-of-stock items without demotion.

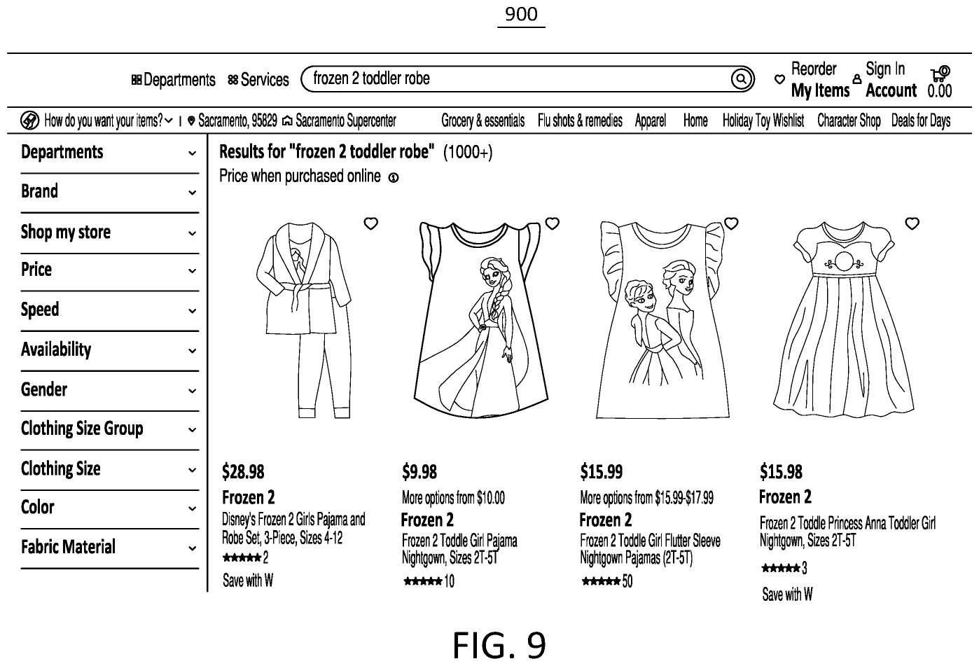

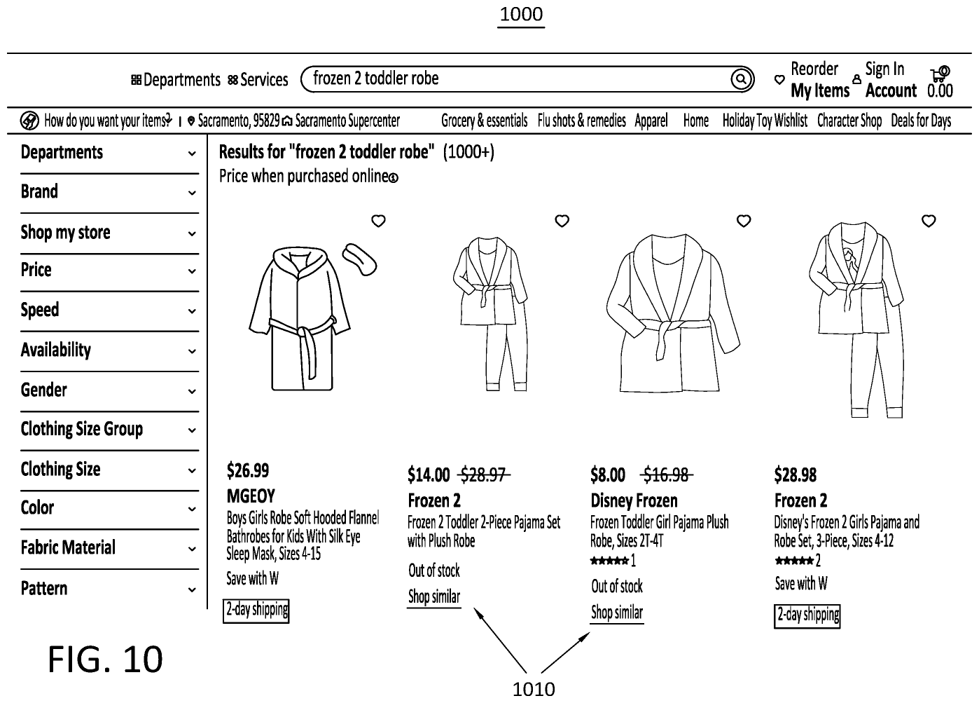

Turning ahead in the drawings, FIG. 9 illustrates a display screen 900 of a user interface showing search results for a query “frozen 2 toddler robe” without using specificity scores to show out-of-stock items. FIG. 10 illustrates a display screen 1000 of a user interface showing search results for the query “frozen 2 toddler robe” using specificity scores to show out-of-stock items. As shown in FIG. 10, there are two items 1010 that are an exact match to the query, which are shown. In FIG. 9, when specificity scores are not considered, items 1010 are not shown, but are instead replaced with other search results that are not out-of-stock.

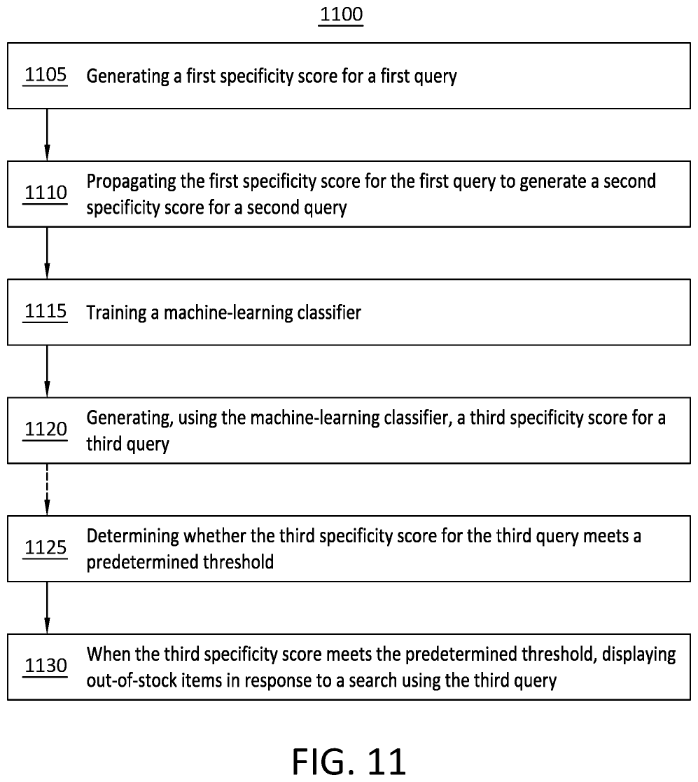

Turning ahead in the drawings, FIG. 11 illustrates a flow chart for a method 1100 of providing engagement-based estimation of query specificity, according to another embodiment. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped.

In many embodiments, system 300 (FIG. 3), specificity system 310 (FIG. 3), and/or web server 320 (FIG. 3) can be suitable to perform method 1100 and/or one or more of the activities of method 1100. In these or other embodiments, one or more of the activities of method 1100 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 1100 and other activities in method 1100 can include using a distributed network including distributed memory architecture to perform the associated activity. This distributed architecture can reduce the impact on the network and system resources to reduce congestion in bottlenecks while still allowing data to be accessible from a central location.

Referring to FIG. 11, method 1100 can include an activity 1105 of generating a first specificity score for a first query. The first query can be similar or identical to queries 701 and/or 702. The first specificity score can be similar or identical to the base specificity score described above. In some embodiments, activity 1105 can include determining a specificity count of unique items purchased based on the first query. The specificity count can be similar or identical to the specificity count described above. In some embodiments, activity 1105 can include determining a co-purchase probability for the first query. The co-purchase probability can be similar or identical to the co-purchase probability described above. In some embodiments, activity 1105 can include generating the first specificity score for the first query based on the specificity count for the first query and the co-purchase probability for the first query. For example, the first specificity score can be generated based on multiplying the specificity count by the co-purchase probability, as described above.

In a number of embodiments, method 1100 also can include an activity 1110 of propagating the first specificity score for the first query to generate a second specificity score for a second query. The second specificity score can be similar or identical to the specificity scores described above, as are propagated to queries.

In many embodiments, activity 1110 can include determining that the second query is equivalent to the first query and setting the second specificity score for the second query to be equivalent to the first specificity score for the first query.

In many embodiments, activity 1110 can include determining that the second query is a subquery of the first query and setting the second specificity score for the second query to represent a lower specificity than the first specificity score for the first query.

In many embodiments, activity 1110 can include determining that the second query is a sibling of the first query and setting the second specificity score for the second query and the first specificity score for the first query to be equivalent to a maximum specificity of queries that are siblings to the first query and the second query. In many embodiments, determining that the second query is the sibling of the first query can involve excluding attributes of product type, product type descriptor, brand, product line, or miscellaneous in determining that the second query is the sibling of the first query.

In many embodiments, activity 1110 can include applying token-level comparison attributes across identical attributes of the first query and the second query, such as described above for single-attribute propagation.

In several embodiments, method 1100 additionally can include an activity 1115 of training a machine-learning classifier at least based on the first query and the second query. In many embodiments, the machine-learning classifier is a binary classifier.

In a number of embodiments, method 1100 further can include an activity 1120 of generating, using the machine-learning classifier, a third specificity score for a third query. For example, the third query can be a query that does not have a specificity score.

In several embodiments, method 1100 additionally and optionally can include an activity 1125 of determining whether the third specificity score for the third query meets a predetermined threshold.

In a number of embodiments, when the third specificity score for the third query meets the predetermined threshold, method 1100 further can include an activity 1130 of displaying out-of-stock items in response to a search using the third query.

Returning to FIG. 3, in some embodiments, communication system 311 can at least partially perform activity 1130 (FIG. 11) of displaying out-of-stock items in response to a search using the third query.

In some embodiments, scoring system 312 can at least partially perform activity 1105 (FIG. 11) of generating a first specificity score for a first query, activity 1110 (FIG. 11) of propagating the first specificity score for the first query to generate a second specificity score for a second query, activity 1115 (FIG. 11) of training a machine-learning classifier at least based on the first query and the second query, and/or activity 1120 (FIG. 11) generating, using the machine-learning classifier, a third specificity score for a third query.

In some embodiments, out-of-stock system 313 can at least partially perform activity 1125 (FIG. 11) of determining whether the third specificity score for the third query meets a predetermined threshold, and/or activity 1130 (FIG. 11) of displaying out-of-stock items in response to a search using the third query.

In many embodiments, the techniques described herein can provide a practical application and several technological improvements. In some embodiments, the techniques described herein can provide for engagement-based estimation of query specificity. The techniques described herein can provide a significant improvement over conventional approaches that fail to take into account the specificity of search queries.

In a number of embodiments, the techniques described herein can solve a technical problem that arises only within the realm of computer networks, as search queries for online search engines do not exist outside the realm of computer networks. Moreover, the techniques described herein can solve a technical problem that cannot be solved outside the context of computer networks. Specifically, the techniques described herein cannot be used outside the context of computer networks, in view of a lack of data, the lack of search result pages, and the inability to perform machine learning models without a computer.

Various embodiments can include a system including one or more processors and one or more non-transitory computer-readable media storing computing instructions that, when executed on the one or more processors, cause the one or more processors to perform certain operations. The operations can include generating a first specificity score for a first query. The operations also can include propagating the first specificity score for the first query to generate a second specificity score for a second query. The operations additionally can include training a machine-learning classifier at least based on the first query and the second query. The operations further can include generating, using the machine-learning classifier, a third specificity score for a third query.

A number of embodiments can include a method being implemented via execution of computing instructions configured to run at one or more processors. The method can include generating a first specificity score for a first query. The method also can include propagating the first specificity score for the first query to generate a second specificity score for a second query. The method additionally can include training a machine-learning classifier at least based on the first query and the second query. The method further can include generating, using the machine-learning classifier, a third specificity score for a third query.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although engagement-based estimation of query specificity has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 7-8 and 11 may include different procedures, processes, and/or activities and be performed by many different modules, in many different orders, and/or one or more of the procedures, processes, or activities of FIGS. 7-8 and 11 may include one or more of the procedures, processes, or activities of another different one of FIGS. 7-8 and 11. As another example, the systems within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform operations comprising:
generating a first specificity score for a first query;
propagating the first specificity score for the first query to generate a second specificity score for a second query;
training a machine-learning classifier at least based on the first query and the second query; and
generating, using the machine-learning classifier, a third specificity score for a third query.

2. The system of claim 1, wherein generating the first specificity score for the first query further comprises:
determining a specificity count of unique items purchased based on the first query;
determining a co-purchase probability for the first query; and
generating the first specificity score for the first query based on the specificity count for the first query and the co-purchase probability for the first query.

3. The system of claim 1, wherein propagating the first specificity score for the first query to generate the second specificity score for the second query further comprises:
determining that the second query is equivalent to the first query; and
setting the second specificity score for the second query to be equivalent to the first specificity score for the first query.

4. The system of claim 1, wherein propagating the first specificity score for the first query to generate the second specificity score for the second query further comprises:
determining that the second query is a subquery of the first query; and
setting the second specificity score for the second query to represent a lower specificity than the first specificity score for the first query.

5. The system of claim 1, wherein propagating the first specificity score for the first query to generate the second specificity score for the second query further comprises:
determining that the second query is a sibling of the first query; and
setting the second specificity score for the second query and the first specificity score for the first query to be equivalent to a maximum specificity of queries that are siblings to the first query and the second query.

6. The system of claim 5, wherein determining that the second query is the sibling of the first query further comprises:
excluding attributes of product type, product type descriptor, brand, product line, or miscellaneous in determining that the second query is the sibling of the first query.

7. The system of claim 1, wherein propagating the first specificity score for the first query to generate the second specificity score for the second query further comprises:
applying token-level comparison attributes across identical attributes of the first query and the second query.

8. The system of claim 1, wherein the machine-learning classifier is a binary classifier.

9. The system of claim 1, wherein the operations further comprise:
determining whether the third specificity score for the third query meets a predetermined threshold.

10. The system of claim 9, wherein the operations further comprise:
when the third specificity score for the third query meets the predetermined threshold, displaying out-of-stock items in response to a search using the third query.

11. A method implemented via execution of computing instructions configured to run at one or more processors, the method comprising:
generating a first specificity score for a first query;
propagating the first specificity score for the first query to generate a second specificity score for a second query;
training a machine-learning classifier at least based on the first query and the second query; and
generating, using the machine-learning classifier, a third specificity score for a third query.

12. The method of claim 11, wherein generating the first specificity score for the first query further comprises:
determining a specificity count of unique items purchased based on the first query;
determining a co-purchase probability for the first query; and
generating the first specificity score for the first query based on the specificity count for the first query and the co-purchase probability for the first query.

13. The method of claim 11, wherein propagating the first specificity score for the first query to generate the second specificity score for the second query further comprises:
determining that the second query is equivalent to the first query; and
setting the second specificity score for the second query to be equivalent to the first specificity score for the first query.

14. The method of claim 11, wherein propagating the first specificity score for the first query to generate the second specificity score for the second query further comprises:
determining that the second query is a subquery of the first query; and
setting the second specificity score for the second query to represent a lower specificity than the first specificity score for the first query.

15. The method of claim 11, wherein propagating the first specificity score for the first query to generate the second specificity score for the second query further comprises:
determining that the second query is a sibling of the first query; and
setting the second specificity score for the second query and the first specificity score for the first query to be equivalent to a maximum specificity of queries that are siblings to the first query and the second query.

16. The method of claim 15, wherein determining that the second query is the sibling of the first query further comprises:
excluding attributes of product type, product type descriptor, brand, product line, or miscellaneous in determining that the second query is the sibling of the first query.

17. The method of claim 11, wherein propagating the first specificity score for the first query to generate the second specificity score for the second query further comprises:
applying token-level comparison attributes across identical attributes of the first query and the second query.

18. The method of claim 11, wherein the machine-learning classifier is a binary classifier.

19. The method of claim 11 further comprising:
determining whether the third specificity score for the third query meets a predetermined threshold.

20. The method of claim 19 further comprising:
when the third specificity score for the third query meets the predetermined threshold, displaying out-of-stock items in response to a search using the third query.
